(19) United States
(12) Patent Application Publication
(10) Pub. No.: US 2020/0305436 A1
(43) Pub. Date: Oct. 1, 2020

(54) Compositions and Methods of Increasing Plant Yield and Improving Pest Resistance

(71) Applicant: BASF Corporation, Florham Park, NJ (US)

(72) Inventors: Jennifer RIGGS, Research Triangle Park, NC (US); Michael McCARVILLE, Research Triangle Park, NC (US)

(21) Appl. No.: 16/306,972

(22) PCT Filed: Jun. 5, 2017
(86) PCT No.: PCT/US2017/035968

§ 371 Date: Dec. 4, 2018

(51) Int. Cl. A01N 51/00; A01N 43/40; A01N 63/22

(52) U.S. Cl. CPC A01N 51/00; A01N 63/22; A01N 43/40

(57) ABSTRACT

The disclosure provides for compositions and methods comprising clothianidin, a Bacillus-based compound or composition, a fungicide, and methods of uses thereof. Also provided are seeds and plants coated or treated with compositions described herein. The disclosure further provides for methods of reducing and/or delaying the resistance of a pest or pest population to one or more plant traits. Also provided for are compositions capable of reducing and/or delaying SCN resistance to one or more plant traits, by applying a composition described herein, for example, one or more compositions comprising clothianidin, a Bacillus firmus, and fluopyram to a seed, plant, and plant part.

### FIELD

The disclosure provides for compositions and methods comprising clothianidin, a Bacillus-based compound or composition, a fungicide, and methods of use thereof.

The disclosure further provides for methods of reducing and/or delaying the resistance of a pest or pest population to one or more plant traits. Also provided for are methods of reducing and/or delaying Soybean cyst nematode (“SCN”) resistance to one or more plant traits, by applying a composition described herein, for example, one or more compositions comprising clothianidin, a Bacillus firmus, and fluopyram to a seed, plant, and plant part.

Seeds, plants, and plant parts treated or coated with compositions described herein are also provided for by the disclosure.

### BACKGROUND

There is a need to develop compositions and/or methods that are capable of improving plant yield while reducing or controlling the negative influence of pests and associated plant or crop damage. There is also a need to develop compositions and/or methods that are capable of managing the resistance of pests and pathogens.

Soybean cyst nematode (SCN, Heterodera glycines) is one of the most economically important soybean pathogens in the United States. Management practices include using resistant varieties and crop rotation. SCN populations virulent to, for example, PI 88788 resistance are becoming more common. To this end, the disclosure provides for formulations comprising, for example, a combination of fluopyram and clothianidin with a Bacillus-based compound or composition, for example, Bacillus firmus, capable of increasing plant yield, reducing damage from pests, and/or managing the resistance of pests and pathogens.

### SUMMARY

In an aspect, the disclosure provides for a method of reducing, delaying, and/or controlling resistance of a pest or pest population to one or more plant traits comprising treating a seed, a plant, or a plant part with one or more compositions comprising:
a) fluopyram and/or an N-oxide thereof;
b) clothianidin; and
c) Bacillus firmus.

The disclosure further provides for a method of reducing, delaying, and/or controlling resistance of a pest or pest population to one or more plant traits comprising treating a seed, a plant, or a plant part with one or more compositions comprising:
a) fluopyram and/or an N-oxide thereof in an application amount from about 0.01 mg ai/seed to about 10 mg ai/seed;
b) clothianidin in an application amount from about 0.01 mg ai/seed to about 10 mg ai/seed; and
c) Bacillus firmus.

In an aspect, the disclosure further provides for a method of reducing, delaying, and/or controlling resistance of a pest or pest population to one or more plant traits comprising treating a seed, a plant, or a plant part with one or more compositions comprising:
a) fluopyram and/or an N-oxide thereof in an application amount from about 0.01 mg ai/seed to about 1.0 mg ai/seed; and
b) clothianidin in an application amount from about 0.01 mg ai/seed to about 1.0 mg ai/seed; and
c) Bacillus firmus.

The disclosure further provides for treated seeds and/or plants comprising
a) fluopyram and/or an N-oxide thereof in an application amount from about 0.01 mg ai/seed to about 1.0 mg ai/seed; and
b) clothianidin in an application amount from about 0.01 mg ai/seed to about 1.0 mg ai/seed; and
c) Bacillus firmus.
   wherein the treated seeds or plants exhibit decreased resistance to plant-parasitic nematodes, for example, Soybean Cyst nematodes.

In an aspect, the disclosure provides for methods of improving plant yield comprising treating a seed, a plant, or a plant part with one or more compositions comprising:
a) fluopyram and/or an N-oxide thereof;
b) clothianidin; and
c) Bacillus firmus;
   wherein the one or more compositions reduce, delay, and/or control resistance of a pest or pest population to one or more plant traits.

In an aspect, the pest comprises a plant-parasitic nematode. In yet another aspect, the pest comprises Soybean Cyst nematodes.

In another aspect, the one or more compositions described herein are applied seed treatments. In yet another aspect, the one or more compositions are applied as seed treatments to cotton, soy, canola, tobacco, peanut, and/or potato seed. In a preferred aspect, the one or more compositions are applied as a seed treatment to soy seed.

The disclosure further provides for compositions and methods comprising a synergistic combination of
a) fluopyram and/or an N-oxide thereof;
b) clothianidin; and
c) Bacillus firmus;
   wherein seeds treated with (a), (b), and (c) delay, reduce, or control plant-parasitic nematode resistance, for example, Soybean Cyst nematode resistance, to one or more plant traits.

In an aspect, the disclosure provides for the one or more compositions described herein and associated methods capable of delaying, reducing, or controlling pest resistance or Soybean Cyst nematode resistance in plants carrying one or more genes selected from Hs1^{pro-1}, Mi-1, Mi-1.2, Hero A, Gpa2, Gro1-4, Rhg1, Rhg4, Mi-3, Mi-9, Cre1, Cre3, Ma, Hsa-1^{Og}, Me3, Rmc1, and CLAVATA3-like peptides. In an aspect, the plant or treated seed is PI 88788 or Peking.

The disclosure further provides for one or more compositions described herein and associated methods capable of delaying, reducing, or controlling Soybean Cyst nematode resistance to soy PI 88788 after 3 generations of Soybean Cyst nematodes.

In yet another aspect, the disclosure provides for one or more compositions comprising (a) fluopyram and/or an N-oxide thereof; (b) clothianidin; and (c) Bacillus firmus capable of delaying, reducing, or controlling Soybean Cyst nematode resistance to soy PI 88788 after 3 generations of Soybean Cyst nematodes relative to one or more compositions comprising (b) clothianidin; and (c) Bacillus firmus and without (a) fluopyram and/or an N-oxide thereof.

Seeds and/or plants treated with compositions described herein are also envisioned.

### BRIEF DESCRIPTION OF THE FIGURES

FIG. 1 sets forth trials evaluating Soybean Cyst Nematode (“SCN”) population adapted to PI 88788 and Peking after 3 generations. SCN infestation and plant vigor was assessed on a scale of 1 (least infestation) to 9 (most infestation).

FIG. 2 sets forth trials evaluating the final SCN egg population for PI 88788 and Peking after 3 generations.

FIG. 3 sets forth trials evaluating SCN population adapted to PI 88788 after 3 generations. SCN infestation and plant vigor was assessed on a scale of 1 (least infestation) to 9 (most infestation). As seen from FIG. 3, the combination of Poncho®/VOTiVO™ and ILeVO® delays adaptation to SCN traits.

FIG. 4 sets forth trials evaluating SCN population adapted to Peking after 3 generations. SCN infestation and plant vigor was assessed on a scale of 1 (least infestation) to 9 (most infestation). As seen from FIG. 3, the combination of Poncho®/VOTiVO™ and ILeVO® delays adaptation to SCN traits.

### DETAILED DESCRIPTION

The disclosure provides for a product or one or more compositions comprising 1-(2-chloro-1,3-thiazol-5-ylmethyl)-3-methyl-2-nitroguanidine (clothianidin), a Bacillus-based compound or composition, a fungicide, and methods of use thereof. In an aspect, the disclosure provides for one or more compositions comprising clothianidin, Bacillus firmus, fluopyram and methods of use thereof. In an another aspect, the disclosure provides for a first composition comprising clothianidin and Bacillus firmus and a second composition comprising fluopyram and methods of use thereof. In yet an another aspect, the disclosure provides for a first composition comprising clothianidin, a second composition comprising Bacillus firmus, and a third composition comprising fluopyram and methods of use thereof.

The disclosure further provides for methods of reducing and/or delaying the resistance of a pest or pest population to one or more plant traits. In an aspect, the disclosure further provides for methods of reducing and/or delaying SCN resistance to one or more plant traits. In another aspect, the disclosure provides for methods of reducing and/or delaying SCN resistance to one or more plant traits, by applying a composition described herein, for example, one or more compositions comprising clothianidin, a Bacillus firmus, and fluopyram to a seed, plant, and plant part. In an aspect, a composition or compositions described herein are only used in seed treatments and are not applied to plants or plant parts.

In an aspect, the disclosure provides for compositions and/or methods that are capable of improving plant yield while reducing or controlling the negative influence of pests and associated plant or crop damage. In another aspect, the disclosure provides for compositions and/or methods that are capable of managing the resistance of pests, for example nematodes, and pathogens by utilizing a composition described herein.

In another aspect, the disclosure provides for methods of reducing pest infestation, for example, nematode or SCN infestation, by applying a composition described herein to a seed, plant, and plant part. In yet another aspect, the disclosure provides for methods of improving plant growth, yield, and/or vigor by applying a composition described herein to a seed, plant, and plant part.

In an aspect, compositions described herein decrease, for example, SCN reproduction, females, and/or eggs/grams of dry root. In another aspect, the disclosure provides for one or more compositions comprising clothianidin, Bacillus firmus, and fluopyram, wherein the seed treatment comprising clothianidin, Bacillus firmus, and fluopyram decreases SCN reproduction, females, and/or eggs/grams of dry root relative to a comparable seed treatment with a composition comprising clothianidin and Bacillus firmus but without fluopyram. In yet another aspect, the disclosure provides for one or more compositions comprising clothianidin, Bacillus firmus, and fluopyram, wherein the seed treatment with a composition comprising clothianidin, Bacillus firmus, and fluopyram decreases SCN reproduction, females, and/or eggs/grams of dry root in an unexpected amount relative to a comparable seed treatment with a composition comprising clothianidin and Bacillus firmus but without fluopyram. In another aspect, the disclosure provides for one or more compositions comprising clothianidin, Bacillus firmus, and fluopyram, wherein seed treatment comprising clothianidin, a Bacillus firmus, and fluopyram decreases SCN reproduction, females, and/or eggs/grams of dry root by about 10%, 20%, 25%, 30%, or 50% or more relative to a comparable seed treatment with a composition comprising clothianidin and Bacillus firmus but without fluopyram.

The disclosure provides for compositions described herein, for example, one or more compositions comprising clothianidin, Bacillus firmus, and fluopyram, wherein seed treatment with a composition comprising clothianidin, Bacillus firmus, and fluopyram exhibits increased vigor and/or biomass in an unexpected amount relative to a comparable seed treatment with a composition comprising clothianidin and Bacillus firmus but without fluopyram. In yet another aspect, the disclosure provides for compositions described herein, for example, one or more compositions comprising clothianidin, a Bacillus firmus, and fluopyram, wherein seed treatment with a composition comprising clothianidin, a Bacillus firmus, and fluopyram exhibits increased vigor and/or biomass by about 10%, 20%, 30%, 40%, or 50% or more relative to a comparable seed treatment with a composition comprising clothianidin and Bacillus firmus but without fluopyram.

The disclosure further provides for compositions described herein, for example compositions comprising clothianidin, Bacillus firmus, and fluopyram, wherein the seed treatment with a composition comprising clothianidin, Bacillus firmus, and fluopyram is an effective means of managing SCN resistance when paired with resistant plant varieties in an unexpected amount relative to a comparable seed treatment with a composition comprising clothianidin and Bacillus firmus but without fluopyram. In an aspect, the disclosure further provides for compositions described herein, for example, compositions comprising clothianidin, Bacillus firmus, and fluopyram, wherein the seed treatment with a composition comprising clothianidin, Bacillus firmus, and fluopyram decreases nematode or SCN resistance relative to a comparable seed treatment with a composition comprising clothianidin and Bacillus firmus but without fluopyram or a composition or compositions comprising fluopyram but without clothianidin and Bacillus firmus.

In yet another aspect, the disclosure further provides for compositions described herein, for example, compositions comprising clothianidin, Bacillus firmus, and fluopyram, wherein seed treatment with a composition comprising clothianidin, Bacillus firmus, and fluopyram decreases nematode or SCN resistance after the second, third, fourth, or fifth generation relative to a comparable seed treatment with a composition comprising clothianidin and Bacillus firmus but without fluopyram.

In an aspect, the disclosure further provides for compositions and methods described herein for decreasing or managing nematode or SCN resistance, wherein the nematode or SCN, has developed resistance after the second, third, fourth, or fifth nematode generation. In another aspect, the disclosure provides for compositions and methods described herein for decreasing or managing nematode or SCN resistance, wherein the nematode or SCN, has developed resistance after the second, third, fourth, or fifth nematode generation.

The disclosure provides for compositions and methods described herein, for example, one or more compositions comprising clothianidin, Bacillus firmus, and fluopyram, wherein the one or more compositions decreases SCN that has developed after the second, third, fourth, or fifth SCN generation. In an aspect, at the end of three, four, or five generations, ILeVO® increases the efficacy of Poncho®/VOTiVO®.

In another aspect, the disclosure provides for compositions and methods comprising a combination of Poncho®/VOTiVO® and ILeVO®. In another aspect, the disclosure provides for a synergistic composition and associated methods comprising a combination of Poncho®/VOTiVO® and ILeVO®, wherein the combination of a fluopyram-based composition, such as ILeVO®, with a clothianidin and Bacillus firmus based composition, such as Poncho®/VOTiVO®, unexpectedly and/or synergistically reduces a pest resistance, for example, SCN's resistance to a plant trait described herein.

In another aspect, the combination of a fluopyram-based composition, such as ILeVO®, with a clothianidin and Bacillus firmus based composition, such as Poncho®/VOTiVO®, delays the development of SCN resistance to, for example, PI88788 and/or Peking. In an aspect, the disclosure provides for seed treatments comprising compositions described herein wherein SCN resistance is delayed, for example, in PI88788 and/or Peking.

The disclosure further provides for compositions or product comprising at least one spore-forming bacterium, at least one insect control agent, at least one genetically modified cotton, corn, or soybean seed. In an aspect, the disclosure further provides for one or more compositions or products comprising Bacillus firmus, clothianidin, and fluopyram, and at least one genetically modified cotton, corn, or soybean seed. In an aspect, the genetically modified seed is insect tolerant, glyphosate tolerant, or combinations thereof. In an aspect, the at one spore-forming bacterium exhibits nematicidal activity and is Bacillus firmus from strain CNCM 1-1582.

In an aspect, the disclosure provides for compositions and methods described herein capable of controlling plant-parasitic nematodes and/or reducing resistance of plant-parasitic nematodes in plants carrying one or more of the following genes Hs1^{pro-1}, Mi-1, Mi-1.2, Hero A, Gpa2, Gro1-4, Rhg1, Rhg4, Mi-3, Mi-9, Cre1, Cre3, Ma, Hsa-1^{Og}, Me3, Rmc1, CLAVATA3-like peptides (e.g. SYV46). In an aspect, disclosure provides for one or more compositions comprising a fluopyram-based composition, such as ILeVO®, with a clothianidin and Bacillus firmus based composition, such as Poncho®/VOTiVO™ and methods described herein are capable of controlling plant-parasitic nematodes and/or reducing resistance of plant-parasitic nematodes in plants carrying one or more of the following genes Hs1^{pro-1}, Mi-1, Mi-1.2, Hero A, Gpa2, Gro1-4, Rhg1, Rhg4, Mi-3, Mi-9, Cre1, Cre3, Ma, Hsa-1^{Og}, Me3, Rmc1, CLAVATA3-like peptides (e.g. SYV46). In an aspect, Bacillus firmus is from strain CNCM 1-1582.

The disclosure provides for a method of reducing plant, root, or plant part damage by treating soil, a seed, plant, root, and/or plant part with one of more active agents described herein. The disclosure provides for a method of reducing plant, root, or plant part damage by treating soil, a seed, plant, root, and/or plant part with a composition including an insecticide, for example fluopyram, with a fungicide. In an aspect, the disclosure provides for a method of reducing plant, root, or plant part damage by treating a soil, a seed, plant, root, or plant part with a composition described herein.

In another aspect, the disclosure provides for a method of reducing plant, root, or plant part damage by treating soil, a seed, plant, root, or plant part with fluopyram together with one of more active agents described herein. In yet another aspect, the disclosure provides for a method of reducing plant, root, or plant part damage by treating a seed, plant, root, or plant part with a synergistic combination of fluopyram together with one of more active agents described herein.

The disclosure also provides for synergistic composition and/or methods comprising, consisting essentially of, or consisting of fluopyram together with clothianidin and Bacillus firmus.

In a further aspect, the disclosure provides for a method of controlling damage, reducing damage, and/or increasing plant yield comprising a plant drench application of a composition comprising, consisting essentially of, or consisting of fluopyram together with clothianidin and Bacillus firmus as a plant drench application.

In another aspect, the disclosure provides for a method of controlling damage, reducing damage, and/or increasing plant yield comprising an in-furrow application of a composition comprising, consisting essentially of, or consisting of fluopyram together with clothianidin and Bacillus firmus as in-furrow application.

In an aspect, the disclosure provides for an active agent for use in a combination described herein selected from the group consisting of acetamiprid, clothianidin, dinotefuran, imidacloprid, nitenpyram, thiacloprid, thiamethoxam, ethiprole, fipronil, imidacloprid, spiromesifen, beta-cyfluthrin, spirodiclofen, flubendiamide, thiodicarb, spirotetramat, Rynaxypyr™ (DuPont/Syngenta), Poncho, Gaucho, Votivo, Votivo with an additional insecticide, cyantraniliprole, Cyazypyr®, Nipsit INSIDE® (Valent), Platinum® (Syngenta), Admire® Pro (Bayer CropScience), Cruiser (Syngenta), Gaucho (Bayer CropScience), Actara (Syngenta), Venom (Valent), Movento® (Bayer CropScience), Larvin® (Bayer CropScience), Belt® (Bayer CropScience), Sepresto® (Bayer CropScience), Envidor® (Bayer CropScience), Baythroid® XL (Bayer CropScience), Calypso (Bayer CropScience), Alias (Mana), Pasada (Mana), Couraze (Cheminova), Assail® (DuPont), Poncho®/VOTiVO™ (Bayer CropScience), Poncho® 1250+VOTiVO™ (Pioneer), Poncho® Beta (Bayer CropScience), Poncho® 600 (Bayer CropScience), Gaucho® 600 (Bayer CropScience), Gaucho®-XT (Bayer CropScience), Aeris® (Bayer CropScience), Prosper® FX (Bayer CropScience), Prosper® Evergol (Bayer CropScience), and/or Requiem® (Agroquest).

In an aspect, the amount of a controlling, damage reducing, yield increasing, or resistance managing composition described herein can be an amount that is effective (“effective amount”) to protect seeds, plant parts, or plants against damage or pest infestation and/or increase plant yield.

In an aspect, a composition or combination of one or more compositions described herein are applied to a seed, soil, plant, or plant part from about 0.01-about 10 mg/ai, from about 0.01-about 5 mg/ai, from about 0.02-about 2 mg/ai, from about 0.025-about 1 mg/ai, from about 0.0075-about 0.75 mg/ai, from about 0.005-about 0.05 mg/ai, from about 0.10 mg ai/seed to about 0.75 mg ai/seed, from about 0.05 mg ai/seed to about 0.75 mg ai/seed, or from about 0.2-about 1.0 mg·ai. In an aspect, a composition or combination of one or more compositions described herein are applied to a seed, soil, plant, or plant part from about 0.01-about 0.5 mg/ai, from about 0.01-about 1.0 mg/ai, from about 0.02-about 2 mg/ai, from about 0.025-about 1 mg/ai, from about 0.075-about 0.75 mg/ai, from about 0.005-about 0.05 mg/ai, from about 0.10 mg ai/seed to about 0.75 mg ai/seed, from about 0.05 mg ai/seed to about 0.75 mg ai/seed, or from about 0.2-about 1.0 mg·ai. In an aspect, a composition or combination of one or more compositions described herein is applied to a seed from about 0.01-about 10 mg/ai seed, from about 0.01-about 5 mg/ai seed, from about 0.02-about 2 mg/ai seed, from about 0.01-about 1 mg/ai seed, from about 0.01-about 0.75 mg/ai seed, from about 0.02-about 1 mg/ai seed, from about 0.2-about 0.75 mg/ai seed, from about 0.05-about 1 mg/ai seed, from about 0.05-about 0.75 mg/ai seed, or about 0.20 mg ai/seed to about 0.75 mg ai/seed, about 0.05 mg ai/seed to about 0.75 mg ai/seed, or from about 0.25-about 0.5 mg/ai seed.

In an aspect, a composition combination described herein is applied to a seed from (a) about 0.1-about 10 mg/ai seed, from about 0.1-about 5 mg/ai seed, from about 0.2-about 2 mg/ai seed, from about 0.2-about 1 mg/ai seed, from about 0.2-about 0.75 mg/ai seed, or from about 0.25-about 0.5 mg/ai seed of fluopyram and (b) about 0.1-about 10 mg/ai seed, from about 0.1-about 5 mg/ai seed, from about 0.2-about 2 mg/ai seed, from about 0.2-about 1 mg/ai seed, from about 0.2-about 0.75 mg/ai seed, or from about 0.25-about 0.5 mg/ai seed of an active agent described herein such as clothianidin. In yet another aspect, a composition combination described herein is applied to a seed from (a) about 0.01-about 1.0 mg/ai seed, from about 0.1-about 0.5 mg/ai seed, from about 0.01-about 1 mg/ai seed, from about 0.1-about 1 mg/ai seed, from about 0.02-about 0.75 mg/ai seed, or from about 0.25-about 0.5 mg/ai seed of fluopyram and (b) about 0.01-about 5 mg/ai seed, from about 0.01-about 0.5 mg/ai seed, from about 0.02-about 2 mg/ai seed, from about 0.02-about 1 mg/ai seed, from about 0.2-about 0.75 mg/ai seed, or from about 0.025-about 0.5 mg/ai seed of an active agent described herein such as clothianidin.

In an aspect, a composition combination described herein is applied to a cotton, soy, canola, tobacco, peanut, and/or potato seed from (a) about 0.1-about 10 mg/ai seed, from about 0.1-about 5 mg/ai seed, from about 0.2-about 2 mg/ai seed, from about 0.2-about 1 mg/ai seed, from about 0.2-about 0.75 mg/ai seed, or from about 0.25-about 0.5 mg/ai seed of fluopyram and (b) about 0.1-about 10 mg/ai seed, from about 0.1-about 5 mg/ai seed, from about 0.2-about 2 mg/ai seed, from about 0.2-about 1 mg/ai seed, from about 0.2-about 0.75 mg/ai seed, or from about 0.25-about 0.5 mg/ai seed of an active agent described herein such as clothianidin.

In another aspect, a composition comprises an active agent described herein, for example fluopyram with an active agent described herein, such as clothianidin, in at least about 0.1%, at least about 0.25%, at least about 0.5%, at least about 1%, at least about 2% at least about 2.5%, at least about 5%, at least about 7.5%, at least about 10%, at least about 25%, or at least about 50%, by weight of a composition. In yet another aspect, a composition comprises an active agent described herein, for example fluopyram with an active agent described herein, such as clothianidin, that is no more than about 1%, no more than about 2.0%, no more than about 2.5%, no more than about 5%, no more than about 7.5%, no more than about 10%, no more than about 25%, no more than about 50%, by weight of a composition.

In an aspect, the disclosure provides for an application rate of a composition or active agent described herein of about 0.1 to about 10 ounces/acre, about 0.2 to about 10 ounces/acre, 0.5 to about 25 ounces/acre, about 1.0 to about 20 ounces/acre, about 10 to about 18 ounces/acre, about 12 to about 18 ounces/acre, about 15 to about 20 ounces per acre. In another aspect, the disclosure provides for an application rate of a composition described herein comprising, consisting of, or consisting essentially of fluopyram and an active agent described herein, such as clothianidin, in an amount of about 5 to about 25 ounces/acre, about 10 to about 20 ounces/acre, about 10 to about 18 ounces/acre, about 12 to about 18 ounces/acre, about 15 to about 20 ounces per acre. In yet another aspect, the disclosure provides for an application rate of fluopyram in an amount of about 0.1 to about 10 ounces/acre, about 0.1 to about 5 ounces/acre; about 0.1 to about 2 ounces/acre, about 0.1 to about 3 ounces/acre, 2 to about 15 ounces/acre, about 5 to about 12 ounces/acre, about 5 to about 10 ounces/acre, about 6 to about 9 ounces/acre, about 8 to about 10 ounces per acre and an the application rate of an active agent or combination of active agents described herein, such as clothianidin, in an amount of about 0.1 to about 10 ounces/acre, about 0.1 to about 5 ounces/acre; about 0.1 to about 2 ounces/acre, about 0.1 to about 3 ounces/acre, of about 2 to about 15 ounces/acre, about 5 to about 12 ounces/acre, about 5 to about 10 ounces/acre, about 6 to about 9 ounces/acre, about 8 to about 10 ounces per acre.

In another aspect, the disclosure provides for a composition comprising an active agent described herein, for example fluopyram with an active agent described herein such as clothianidin, at about 0.0025% to about 0.25%, about 0.1% to about 1%, about 0.1% to about 2.5%, about 0.5% to about 2.5%, about 1% to about 2%, about 1% to about 3%, about 1% to about 5%, about 1% to about 10%, about 2% to about 10%, about 5% to about 10%, about 5% to about 20%, about 10% to about 25%, about 10% to about 50%, about 25% to about 50%, or about 20% to about 80%, and about 95% or more by weight of a composition.

In an aspect, a composition or formulation described herein contain between 0.1 and 95 percent by weight of active. The active ingredient concentration can be about 5-25%, 10-50%, about 10-75%, about 20-50%, or about 5-90% by weight of the composition. The concentrations per liter of volume can be about 50-about 800 grams active per liter, about 100-about 700 grams active per liter, about 200-about 600, about 400-about 600, about 300-about 700 grams, about 400-about 800, about 600-about 800, about 600-about 700 grams active per liter. In an aspect, the composition can also include one or more chelating agents.

In an aspect, an active agent described herein further includes a nematode treating compound or composition. In yet aspect, a compound or composition with insecticidal and nematicidal properties includes clothianidin. In another aspect, an insecticidal or a compound or composition with insecticidal and nematicidal properties described herein includes Poncho®/VOTiVO™ (Bayer CropScience), Poncho® Beta (Bayer CropScience), Poncho® 600 (Bayer CropScience), Poncho® 1250+VOTiVO® (Bayer CropScience), Belay® (Valent), Prosper® FX (Bayer CropScience), and/or Prosper® Evergol. In another aspect, a composition described herein includes clothianidin with a Bacillus-based compound or composition, for example, Bacillus firmus.

In an aspect, a composition described herein, for example fluopyram with an active agent described herein, can be converted to the customary formulations, such as solutions, emulsions, suspensions, powders, foams, pastes, granules, aerosols, very fine capsules in polymeric substances and in coating compositions for seed, and also ULV cold- and warm-fogging formulations.

These formulations are produced in a known manner, for example by mixing the active compounds with extenders, that is liquid solvents, pressurized liquefied gases and/or solid carriers, optionally with the use of surface-active agents, that is emulsifiers and/or dispersants and/or foam formers. If the extender used is water, it is also useful to employ for example organic solvents as cosolvents. Suitable liquid solvents are essentially: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers are those liquids which are gaseous at ambient temperature and at atmospheric pressure, for example aerosol propellants such as halogenated hydrocarbons and also butane, propane, nitrogen and carbon dioxide. As solid carriers there are suitable: for example, ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example, crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

Colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc, can also be used.

Plants are understood as meaning, in the present context, all plants and plant populations, such as desired and undesired wild plants or crop plants (including naturally occurring crop plants). Crop plants or crops may be plants which can be obtained by conventional breeding and optimization methods or else by biotechnological and genetic engineering methods or by combinations of these methods, including the transgenic plants and including the plant varieties capable or not capable of being protected by plant breeders' rights.

The disclosure further provides for methods described herein where seeds or plants treated with compositions described herein are selected from one or more of cotton, corn, vegetables, potato, soy, edible and dry beans, tobacco, coffee, fruits, nuts, peanuts, sugarbeets, potatoes, wheat, barley, sorghum and/or flowers, canola, tree-nuts. In a particularly aspect, the disclosure further provides for methods described herein where seeds or plants treated with compositions described herein soy.

In an aspect, a composition described herein is applied to a soil, plant, crop, seed, or plant part thereof in a single application step. In another aspect, a composition described herein is applied to a plant, crop, seed, or plant part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

In an aspect, a compound or composition described herein is applied to a seed in a single application step prior to planting. In another aspect, a compound or composition described herein is applied to a seed in a single application step prior to planting.

In another aspect, a composition described herein is applied to soil, plant, crop, seed, or plant part thereof at the time of planting to about 30 minutes, about 30 minutes to about 1 hour, about 1 hour to about 4 hours, about 4 hours to about 12 hours, about 1 hour to about 1 day, about 1 day to about 5 days, about 5 days to about 10 days, about 10 days to about 20 days, about 10 days to about 50 days, about 20 days to about 50 days, about 35 to about 50 days, about 6 months to about 24 months, about 12 months to about 18 months or any combination thereof. In yet another aspect, a composition described herein is applied to a soil, plant, crop, seed, or plant part thereof in one or more application intervals of about 30 minutes, about 1 hour, about 2 hours, about 6 hours, about 8 hours, about 12 hours, about 1 day, about 5 days, about 7 days, about 10 days, about 12 days, about 14 days, about 21 days, about 28 days, about 35 days, about 45 days, about 50 days, or about 6 months or more. In another aspect, a seed can be treated by a composition described herein about 1 month to 18 months, about 6 to about 18 months, or about 12 to about 18 months prior to planting.

In another aspect, a composition described herein is applied to a soil, plant, crop, seed, or plant part thereof (1) at the time of planting to about 1 hour after planting and (2) at about 30 to about 50 days, about 25 to about 40 days, or about 25 to about 35 days after planting, for example, as a side dress.

In an aspect, a composition described herein is applied to a plant, crop, seed, or plant part thereof one or more times during a growing, planting, or harvesting season. In another aspect, a compound or composition described herein is applied to a plant, crop, seed, or plant part thereof in one, two, three, four, or five or more times during a growing, planting, or harvesting season. In another aspect, a compound or composition described herein is applied to a plant, crop, seed, or plant part thereof only one time, no more than two times, or no more than three times during a growing, planting, or harvesting season. In yet another aspect, a compound or composition is applied in a single step to a seed. In yet another aspect, a seed described herein is planted in a one-pass application step.

In another aspect, a compound or composition described herein is applied to soil, plant, crop, seed, or plant part thereof in an application regimen at about 1 hour to about 3 hours after the first application and followed by a second application at about 3 hours to about 6 hours; at about 1 hour to about 3 hours after the first application and followed by a second, third, or fourth application at about 12 hours to about 24 hours about 1 to about 7 days after the first application and followed by a second application at about 10 to about 14 days. In yet another aspect, a compound or composition described herein is applied to a seed prior to planting and a foliar application is made at about 1 day to about 5 days, about 5 days to about 10 days, about 10 days to about 20 days, about 20 days to about 50 days, about 40 days to about 60 days, or about 20 days, about 30 days, about 40 days, about 45 days, about 50 days, or any combination thereof, after planting.

In another aspect, the disclosure provides for pre-plant, pre-emergent, post-emergent, application steps or combinations thereof. In another aspect, a compound or composition described herein is first applied in a pre-plant step and followed by one or more pre-emergent or post-emergent steps. In yet another aspect, the disclosure provides for only a pre-plant step.

Method described herein can be used in the treatment of genetically modified organisms (GMOs), e.g. plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference—RNAi—technology). A heterologous gene that is located in the genome is also called a transgene. A transgene that is defined by its particular location in the plant genome is called a transformation or transgenic event.

In an aspect, plants can be obtained by traditional breeding and optimization methods or by biotechnological and recombinant methods, or combinations of these methods, including the transgenic plants and including the plant varieties which are capable or not capable of being protected by Plant Breeders' Rights.

In another aspect, plant species and plant varieties which are found in the wild or which are obtained by traditional biological breeding methods, such as hybridization or protoplast fusion, and parts of these species and varieties are treated. In a further preferred embodiment, transgenic plants and plant varieties which were obtained by recombinant methods, if appropriate in combination with traditional methods (genetically modified organisms) and their parts are treated.

Plant parts should be understood as meaning all above ground and subsoil parts and organs of plants, such as shoot, leaf, flower, root, leaves, needles, stalks, stems, fruiting bodies, fruits and seeds, tubers and rhizomes. Plant parts also include harvested crops, and also vegetative and generative propagation material, for example cuttings, tubers, rhizomes, slips and seeds.

Seeds, plant parts, and plants may be treated with the described compositions by applying the compounds or compositions directly to the seed, plant part, or plant. In another aspect, the seed, plant part, or plant may be treated indirectly, for example by treating the environment or habitat in which the seed, plant part, or plant is exposed to. Conventional treatment methods may be used to treat the environment or habitat including dipping, spraying, fumigating, chemigating, fogging, scattering, brushing on, shanking or injecting.

According to the invention the treatment of the plants and seeds with a composition described herein, for example fluopyram with an active agent, can be carried out directly by the customary treatment methods, for example by immersion, spraying, vaporizing, fogging, injecting, dripping, drenching, broadcasting or painting, and seed treatment.

In yet another aspect, a composition herein treats or reduces infestation of an insect or pest selected from the group consisting of a Soybean cyst nematode (SCN, Heterodera glycines), Chinch bug, Corn flea beetle, Corn leaf aphid, Cutworm—black, Grape colaspis, Seedcorn maggot, Southern corn leaf beetle, Southern corn rootworm, Southern green stinkbug, Indian meal moth, Lesser grain borer, Red flour beetle, Rice weevil, Rusty grain beetle, Sugarcane beetle, White grub, European, Chafer larvae, May/June beetle larvae, Japanese beetle larvae, Thrips, Wireworm, Aphid, Greenbug, Yellow & White sugarcane aphid, English grain aphid, Bean leaf Beetle, Leafhoppers, Three Cornered Alfalfa Hopper, Black bean aphids, Flea beetles, Leafminers, Subterranean springtails, Sugarbeet leafhoppers, and Sugarbeet root maggot.

In an aspect, a compound or composition described herein is formulated as a foliar composition, a foliar spray, solution, emulsion, coating formulation, non-pesticidal or pesticidal coating formulation, encapsulated formulation, solid, liquid, fertilizer, paste, granule, powder, suspension, or suspension concentrate. In another aspect, a compound or composition described herein may be employed alone or in solid, dispersant, or liquid formulation. In yet another aspect, a compound or composition described herein is formulated as a tank-mix product.

In another aspect, a compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations.

In another aspect, a composition disclosed herein may optionally include one or more additional compounds providing an additional beneficial or otherwise useful effect. Such compounds include, without limitation, an adhesive, a surfactant, a solvent, a wetting agent, an emulsifying agent, a carrier, an adjuvant, a diluent, a dispersing agent an insecticide, a pesticide, a fungicide, a fertilizer of a micronutrient or macronutrient nature, an herbicide, a feeding inhibitor, an insect molting inhibitor, an insect mating inhibitor, an insect maturation inhibitor, a nematocide, a nutritional or horticultural supplement, or any combination thereof. In an aspect, a composition described herein is odor free. In another aspect, the surfactant is Genapol, for example Genapol X-080.

In another aspect, a compositions described herein can be combined with a fertilizer. Examples of fertilizers capable of being used with the compositions and methods described herein include, for example, Urea, Ammonium Nitrate, Ammonium Sulfate, Calcium Nitrate, Diammonium Phosphate, Monoammonium phosphate, Triple Super Phosphate, Potassium Nitrate, Potassium nitrate, nitrate of potash, Potassium Chloride, muriate of potash, di and mono potassium salts of phosphite/phosphonate.

Fluopyram has the chemical name N-{2-[3-chloro-5-(trifluoromethyl)-2-pyridinyl]ethyl}-2-(trifluoromethyl) benzamide and a structure as set forth in Formula I:

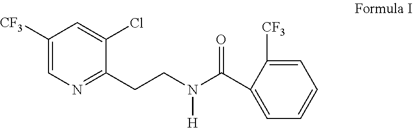 [SMILES: O=C(NCCc1ncc(C(F)(F)F)cc1Cl)c1ccccc1C(F)(F)F]

as well as the N-oxides of the compound thereof. Fluopyram is a fungicide belonging to the chemical class of pyridylethylbenzamides. Fluopyram and its manufacturing process starting from known and commercially available compounds is described in EP-A-1 389 614, which is hereby incorporated by reference in its entirety. Fluopyram is a fungicide for treating phytopathogenic diseases. The compound is also described in U.S. Pat. No. 7,572,818, which is hereby incorporated by reference in its entirety.

### Kit

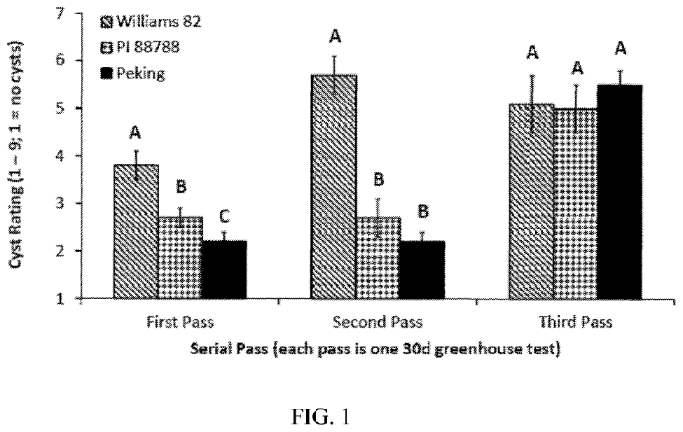

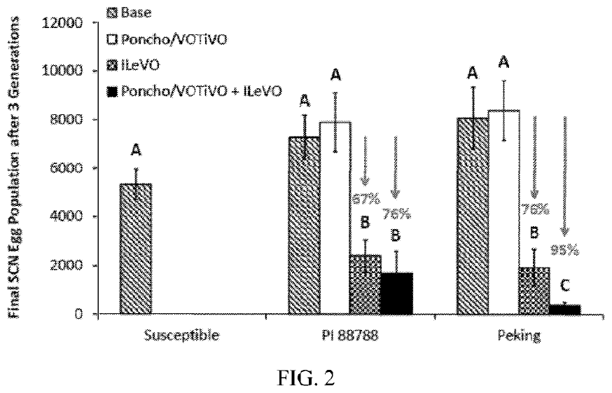

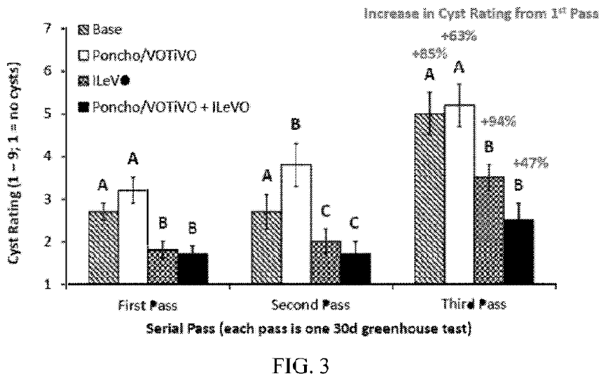

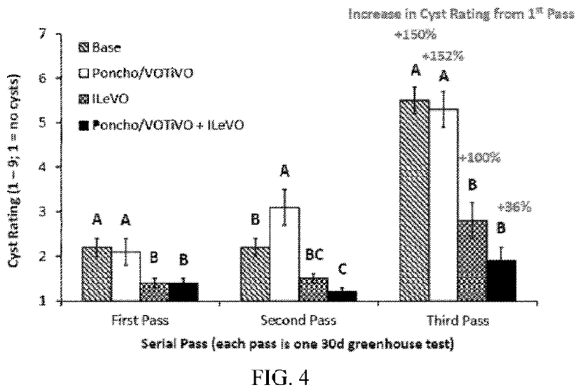

In another aspect, the disclosure provides for a kit comprising, consisting essentially of, or consisting of any of the compounds or compositions disclosed herein. In an aspect, the kit includes any of the combination of compounds or compositions described in Example 1 or FIGS. 1-4. In another aspect, the kit provides for the compositions described in Example 1 or FIGS. 1-4, applied in a manner that is consistent with the methodology of these examples and figures. In another aspect, the kit provides instructions or guidance regarding the use of the compositions or methods described herein.

In an aspect, the kit includes instructions describing the methodology described herein. In another aspect, the kit includes instructions describing the methodology set forth in any of Example 1 or FIGS. 1-4. In an aspect, the instructions are included with the kit, separate from the kit, in the kit, or are included on the kit packaging.

The following examples serve to illustrate certain aspects of the disclosure and are not intended to limit the disclosure.

### EXAMPLES

### Example 1

A greenhouse experiment was conducted to investigate whether nematode protectant seed treatments could delay the development of virulence to plant resistance traits in a population of soybean cyst nematodes. Herein, it was tested whether two nematode protectant seed treatments, a clothianidin based composition, such as VOTiVO, and a fluopyram based composition, such as ILeVO®, alone or in combination could delay the evolution of virulence to native SCN resistance traits. The effect of these seed treatments was tested on two resistance sources, PI 88788 and Peking. The SCN population used was collected from a soybean field in Nebraska and was classified as HG type 2.5.7. This SCN population is partially virulent to PI 88788, but avirulent to Peking. The use of an HG type 2.5.7 allowed us to investigate the benefit of seed treatments for plant traits for which virulence is already common (PI 88788) and for traits which virulence is still rare in the SCN pest population (for example, Peking).

Eight experimental treatments plus one control treatment was undertaken. The eight experimental treatments were created by fully crossing the factors of soybean variety (PI 88788 and Peking) and seed treatment (fungicide base, Poncho/VOTiVO, ILeVO and Poncho/VOTiVO+ILeVO). The control treatment included an SCN-susceptible variety, Williams 82, treated with the base fungicide seed treatment. Seeds were treated with a Hege bowl treater by Bayer (Research Triangle Park, N.C.). Plants of each treatment were grown in containers residing within a greenhouse water bath that maintained a constant soil temperature between 26.7° C. and 28.9° C. allowing for SCN to complete a single generation of reproduction in approximately 30 days.

Depending on the treatment, the seeds were treated with Poncho/VOTiVO, 0.075 mg ai/seed fluopyram, Poncho/VOTiVO with 0.075 mg ai/seed fluopyram, and nontreated control. A nontreated susceptible (Williams 82) served as a check for a total of 9 treatments.

One goal of this trial was to simulate multiple years of SCN reproduction in the greenhouse. Three to six generations of SCN reproduction can be completed in a single field season. Seed treatment efficacy will also vary throughout the growing season. In the case of VOTiVO and ILeVO, nematode efficacy is greater earlier in the season and declines as the season progresses. Accordingly, this trial focused on simulating the first generation of SCN reproduction in the greenhouse. This allowed a focus on the generation of SCN reproduction that would be most affected by seed treatment usage and also study multi-year field effects on a condensed timeline.

A serial passage experiment that was an adaptation of the Standard Cyst Evaluation method developed by Niblack, T. L., A. L. Colgrove, K. Colgrove, and J. P. Bond. 2008. Shift in virulence of soybean cyst nematode is associated with use of resistance from PI 88788. Plant Health Progress doi:10.1094/PHP-2008-0118-01-RS, the contents of which is herein incorporated by reference in its entirety, was designed. In the adapted method, SCN populations were increased on a single treatment for three generations before being tested for their virulence to PI 88788 and Peking using an HG type test. Each SCN generation was increased on a newly seeded plant to simulate the relative efficacy from seed treatments at the start of a new growing season. Therefore, the three greenhouse generations were intended to more closely represent three growing seasons than three generations within a single growing season.

The nine treatments outlined previously were arranged in a randomized complete block design with six replications. A second run of the experiment with six additional replications was started approximately one week after the first run began (Table 1). Each treatment was replicated 12 times (108 total experimental units). Each experimental unit in a single SCN included a population that began with 1,000 SCN eggs used to inoculate a single plant at the start of the first generation. Each SCN population was confined to a 125-ml-container containing a single plant grown from seed. Containers were inoculated six to eight days after planting. At the conclusion, each of the generation roots were sprayed with water to dislodge SCN females. Females were then ground on a 250-μm-pore sieve using a motorized rubber stopper to release the eggs within. Eggs were captured on a 25-μm-pore sieve resting below a 75-μm-pore sieve. All the eggs captured from a single container were then suspended in water and used to inoculate a new set of plants. In this manner eggs were collected from the first generation of SCN and used to inoculate a new set of plants constituting the second generation. This process was then repeated to collect eggs from the second generation and infest a third set of plants constituting the third generation. Each experimental unit developed on plants from the same treatment in the first generation, second generation and third generation. For example, an SCN population inoculated on control plants in the first generation was re-inoculated on control plants in both the second and third generations.

Data were collected on plant growth variables and SCN infection at the end of each generation. Plant vigor was visually assessed on a one to nine scale (nine being most vigorous) prior to washing roots. Soil was then dislodged from the roots of plants and the severity of SCN infection was visually assessed. The cyst rating was a visual assessment of the population density of SCN females on plant roots. A value of one would signify no females were visible, while a value of nine would indicate the entire root system was densely packed with females (see, for example, Table 2). At the end of the third and final generation additional data was taken on the number of SCN eggs per plant and the dry mass of both plant shoots and roots. The number of eggs per plant was measured after SCN females were ground and the eggs were captured on the 25-μm-pore sieve. The number of eggs captured was estimated by suspending the eggs in 100 ml of water and counting the number of eggs present in a 1 ml representative sample using a stereomicroscope. The dry mass of shoot and root systems were measured by cutting plants in half at the soil line after SCN females were washed free. Plants were then dried for 48 hours at 60° C. prior to being weighed on a bench top scale.

Egg counts conducted at the end of third generations revealed SCN populations were too low for certain treatments to immediately conduct and HG type test. We therefore increased SCN populations for every treatment on the control treatment for a single generation. This allowed us to increase SCN populations without applying any selection pressure that would influence the results of the HG type test. A single generation of population increase on the control was sufficient to provide enough inoculum for the HG type test.

The HG type test was used to measure relative virulence to PI 88788 and Peking for each of the experimental units. The HG type test was modified to eliminate replication and reduce the number of resistance sources included. An HG type test suggests six or more replications per SCN population. Since the experiment already included twelve replications per treatment a single replication of the HG type test was conducted per experimental unit. The number of resistance sources included was reduced to two. In a standard HG type test an SCN population is tested for reproductive capacity on seven sources of SCN resistance and a susceptible control. In the experiment two sources of resistance were utilized, PI 88788 and Peking. In addition, a control population was also included that had a known level of virulence to PI 88788 but was avirulent to Peking. The susceptible control variety was therefore eliminated from our HG type test. Therefore, from each experimental unit we prepared two 1,000 egg inoculums, one for a container with a PI 88788 plant and one for a container with a Peking plant. After inoculation plants were allowed to develop for 30 d. At the end of 30 d SCN females were dislodged from the roots of each container and the total number of females present was counted under a dissecting microscope.

TABLE 1
Schedule of experimental procedures.

| | | | Plants | Females | Eggs |
|---|---|---|---|---|---|
| Activity | Planted | Inoculated^{a} | Harvested | Collected | Collected |
| First | | | | | |
| Generation | | | | | |
| First run^{a} | 5-Dec | 11-Dec | 10-Jan | 11-Jan | 12-Jan |
| Second run | 14-Dec | 22-Dec | 21-Jan | 21-Jan | 21-Jan |
| Second | | | | | |
| Generation | | | | | |
| First run | 6-Jan | 13-Jan | 10-Feb | 11-Feb | 11-Feb |
| Second run | 15-Jan | 22-Jan | 21-Feb | 22-Feb | 23-Feb |
| Third | | | | | |
| Generation | | | | | |
| First run | 5-Feb | 12-Feb | 14-Mar | 15-Mar | 15-Mar |
| Second run | 16-Feb | 22-Feb | 24-Mar | 25-Mar | 25-Mar |

^{a}Plants were inoculated with 1,000 soybean cyst nematode eggs in the first generation and HG type test. The second and third generation plants were inoculated with all the eggs recovered from the preceding generation.
^{b} Two runs of the experiment were conducted. Each run consisted of six replications arranged in a randomized complete block design.

TABLE 2
Cyst damage rating scale.

| | | Approximate number |
|---|---|---|
| Rating^{a} | Description of appearance | of females present |
| 1 | No females visible | 0 |
| 1.5 | Females visible | 1-5 |
| 3 | Some females visible | 15-20 |
| 5 | Moderate number of females visible | 40-60 |
| 7 | High number of females visible | 100-150 |
| 9 | Roots completely covered in females | 200+ |

^{a}Ratings were done on a continuous scale with the following benchmarks provided to the person evaluating.

1. A method of reducing, delaying, and/or controlling resistance of a pest or pest population to one or more plant traits comprising treating a seed, a plant, or a plant part with one or more compositions comprising:
a) fluopyram and/or an N-oxide thereof;
b) clothianidin; and
c) Bacillus firmus.

2. The method according to claim 1, wherein said pest or pest population comprises Soybean Cyst nematodes.

3. The method according to claim 1, comprising treating a seed, a plant, or a plant part with one or more compositions comprising:
a) fluopyram and/or an N-oxide thereof in an application amount from about 0.01 mg ai/seed to about 10 mg ai/seed;
b) clothianidin in an application amount from about 0.01 mg ai/seed to about 10 mg ai/seed; and
c) Bacillus firmus.

4. The method according to claim 3, comprising treating a seed, a plant, or a plant part with one or more compositions comprising:
a) fluopyram and/or an N-oxide thereof in an application amount from about 0.01 mg ai/seed to about 1.0 mg ai/seed; and
b) clothianidin in an application amount from about 0.01 mg ai/seed to about 1.0 mg ai/seed; and
c) Bacillus firmus.

5. The method according to claim 1, wherein said one or more compositions are applied seed treatments.

6. The method according to claim 1, wherein said one or more compositions are applied as seed treatments to cotton, soy, canola, tobacco, peanut, and/or potato seed.

7. The method according to claim 6, wherein said one or more compositions are applied as a seed treatment to soy seed.

8. The method according to claim 1, wherein said one or more compositions comprises a synergistic combination of
a) fluopyram and/or an N-oxide thereof;
b) clothianidin; and
c) Bacillus firmus;
wherein seeds treated with (a), (b), and (c) delay, reduce, or control plant-parasitic nematode resistance to one or more plant traits.

9. The method according to claim 8, wherein said plant-parasitic nematode is Soybean Cyst nematode.

10. The method according to claim 9, wherein the one or more compositions comprising (a), (b), and (c) delay, reduce, or control Soybean Cyst nematode resistance to one or more plant traits in soy seeds after a second generation of Soybean Cyst nematode.

11. The method according to claim 9, wherein said one or more compositions comprising (a), (b), and (c) delay, reduce, or control Soybean Cyst nematode resistance to one or more plant traits in soy seeds after the third generation of Soybean Cyst nematode.

12. The method according to claim 9, wherein the one or more compositions delays, reduces, or controls Soybean Cyst nematode resistance in plants carrying one or more genes selected from Hs1^{pro-1}, Mi-1, Mi-1.2, Hero A, Gpa2, Gro1-4, Rhg1, Rhg4, Mi-3, Mi-9, Cre1, Cre3, Ma, Hsa-1^{Og}, Me3, Rmc1, and CLAVATA3-like peptides.

13. The method according to claim 12, wherein the one or more compositions delays, reduces, or controls Soybean Cyst nematode resistance in one or more plants carrying one or more genes selected from Rhg1 or Rhg4.

14. The method according to claim 1, wherein the plant trait is PI 88788 or Peking.

15. The method according to claim 14, wherein the one or more compositions delay, reduce, or control Soybean Cyst nematode resistance to soy PI 88788 or Peking.

16. The method according to claim 15, wherein the one or more compositions delay, reduce, or control Soybean Cyst nematode resistance to soy PI 88788 after 3 generations of Soybean Cyst nematodes.

17. The method according to claim 15, wherein the one or more compositions comprising (a) fluopyram and/or an N-oxide thereof; (b) clothianidin; and (c) Bacillus firmus delay, reduce, or control Soybean Cyst nematode resistance to soy PI 88788 after 3 generations of Soybean Cyst nematodes relative to one or more compositions comprising (b) clothianidin; and (c) Bacillus firmus and without (a) fluopyram and/or an N-oxide thereof.

18. The method according to claim 1, wherein said Bacillus firmus is from strain CNCM 1-1582

19. A treated soybean PI 88788 seed comprising
a) fluopyram and/or an N-oxide thereof in an application amount from about 0.01 mg ai/seed to about 1.0 mg ai/seed; and
b) clothianidin in an application amount from about 0.01 mg ai/seed to about 1.0 mg ai/seed; and
c) Bacillus firmus.

20. A method of improving plant yield comprising treating a seed, a plant, or a plant part with one or more compositions comprising:
a) fluopyram and/or an N-oxide thereof;
b) clothianidin; and
c) Bacillus firmus;
wherein the one or more compositions reduce, delay, and/or control resistance of a pest or pest population to one or more plant traits.

21. (canceled)

22. (canceled)

23. (canceled)

24. (canceled)

25. (canceled)
